(19) United States
(12) Patent Application Publication
(10) Pub. No.: US 2005/0096838 A1
(43) Pub. Date: May 5, 2005

(54) Method for recognizing traveling lane and making lane change

(75) Inventor: Il-Sang Jung, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 10/964,836

(22) Filed: Oct. 13, 2004

(30) Foreign Application Priority Data
Nov. 4, 2003 (KR) 10-2003-0077545

(51) Int. Cl. G01C 21/26

(52) U.S. Cl. 701/200; 348/148

(57) ABSTRACT

Methods and systems for recognizing a vehicle traveling lane and making a lane change are provided. Preferred methods and systems recognize the lane on which a vehicle is traveling and if the vehicle speed of that lane is noticeably slower compared to others, then the vehicle receives an order to move to a faster lane if an open space for changing lanes is available, which can provide more efficient use of the roadway.

### CROSS-REFERENCE TO RELATED APPLICATIONS

The present application is based on, and claims priority from, Korean Application Serial Number 10-2003-0077545, filed on Nov. 04, 2003, the disclosure of which is hereby incorporated by reference herein in its entirety.

### FIELD OF THE INVENTION

The present invention relates to a method for recognizing a vehicle traveling lane and making a lane change. More particularly, the present invention is adapted to precisely recognize the current lane of the vehicle and to change lanes by using the result of such recognition.

### BACKGROUND OF THE INVENTION

A conventional method for lane recognition used in an autonomous vehicle system has merely detected whether the vehicle is within a designated traveling lane of a roadway so as to prevent lane deviation. Thus, the conventional system does not recognize the particular lane on which the vehicle is traveling.

That is, in such a system, the left and right lines of the frontal visual field of the vehicle are photographed by a vision camera and are recognized merely as lane boundaries. In such system, a determination is made of whether the vehicle is traveling within the relevant traveling lane.

That conventional method however has clear drawbacks particularly upon use with an autonomous vehicle system. For instance, vehicles will tend to concentrate only on a single lane, potentially causing traffic congestion and otherwise resulting in inefficient use of the roadway.

### SUMMARY OF THE INVENTION

According to a preferred embodiment of the present invention, methods and systems are provided to recognize the lane on which a vehicle is traveling and to move the vehicle to a faster lane if the vehicle speed of the relevant lane is slower than other lanes, thereby allowing the roadway to be more effectively used. In one aspect, the invention provides methods for lane recognition of a vehicle that may suitably include determining lane boundaries a vehicle traveling on a road delineated with lane marker patterns; and then determining which lane the vehicle is currently traveling on by comparing the determined lane boundaries with pre-saved lane recognition pattern data.

In preferred aspects, a method for lane recognition may comprise the following steps: determining such as by photographing the frontal visual field of the vehicle such as by using a vision sensor from a vehicle traveling on a road delineated with different lane marker patterns; determining data of left and right lane boundaries of the vehicle from the image photographed in the above step; and determining which lane the vehicle is currently traveling on by comparing the extracted lane boundary data with a pre-saved lane recognition pattern data.

Such methods for lane recognition may further comprise a step of executing a lane deviation warning if the extracted lane boundary data and lane recognition pattern data do not at least substantially match with each other.

In a further aspects, methods for making a lane change are provided and may comprise steps of transmitting speed and current lane information of a vehicle measured to an information center; computing an average vehicle speed per each lane at the information center on the basis of the vehicle speed and traveling lane information inputted from a plurality of vehicles, then comparing the average vehicle speed per each lane, and if the average vehicle speed of a certain lane is slower than other lanes, then ordering certain vehicles traveling on a slower lane to change their lanes to a faster lane; and determining whether an open space for changing lanes is available.

In particularly preferred aspects, methods of the invention for making a lane change may comprise steps of:
transmitting the vehicle speed and current lane information measured by an On Board Equipment (OBE) to a traffic information center via a Road Side Equipments (RSE); computing the average vehicle speed per each lane at the traffic information center on the basis of the vehicle speed and traveling lane information inputted from a plurality of vehicles, then comparing the average vehicle speed per each lane, and if the average vehicle speed of a certain lane is slower than other lanes, then ordering certain vehicles which are traveling on a congested lane to change their lanes to a faster lane via the RSE; determining whether an open space for changing lanes is available (e.g. not occupied by another vehicle); and changing lanes by activating the steering device if a space for changing lanes is available.

Such methods for making a lane change may further comprise steps of: waiting for a predetermined period of time if an open space for changing lanes is not obtained at the above open lane determining step, and if the space is available, then changing lanes; and maintaining the vehicle on the current lane if an open space for changing lanes is not available.

It is understood that the term “vehicle” or other similar term as used herein is inclusive of motor vehicles in general such as passenger automobiles, buses, trucks, various commercial vehicles, and the like.

Other aspects of the invention are discussed below.

### BRIEF DESCRIPTION OF THE DRAWINGS

For a better understanding of the nature and objects of the present invention, reference should be made to the following detailed description with the accompanying drawings, in which:

FIG. 1 is a flowchart for describing a method for lane recognition according to an embodiment of the present invention;

FIG. 2 illustrates a roadway enabled to apply a method for lane recognition according to an embodiment of the present invention;

FIG. 3 is a photographic image showing the frontal visual field of the vehicle with respect to a method for lane recognition according to an embodiment of the present invention;

FIG. 4 is a table representing a lane recognition pattern data used in a method for lane recognition according to an embodiment of the present invention;

FIG. 5 is a block diagram of a system performing a method for lane change according to an embodiment of the present invention; and

FIG. 6 is a flowchart describing a method for lane change according to an embodiment of the present invention.

### DETAILED DESCRIPTION OF THE PREFERRED EMBODIMENTS

One or more preferred embodiments of the present invention will now be described in detail with reference to the attached drawings.

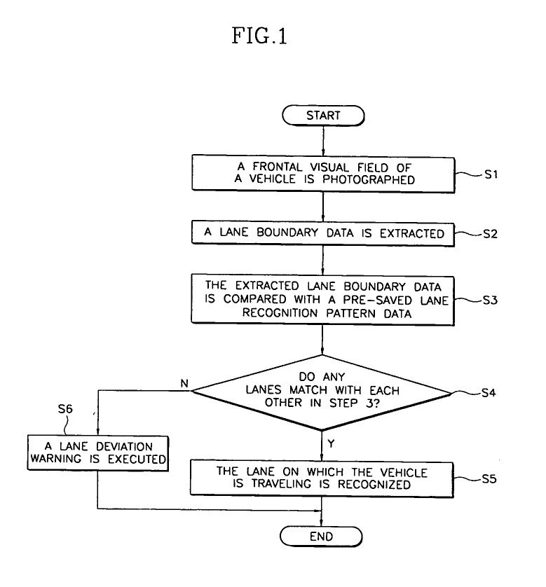

Referring to FIG. 1, a method for lane recognition according to an embodiment of the present invention includes a step of determining such as by photographing the frontal visual field of the vehicle suitably by using a vision sensor (step 1).

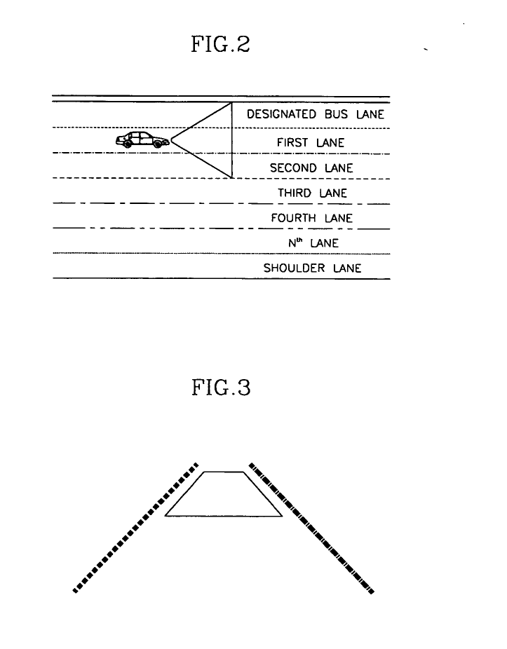

With reference to FIG. 2, each lane boundary is delineated with line patterns which may differ, and when photographed, an image is captured as shown in FIG. 3.

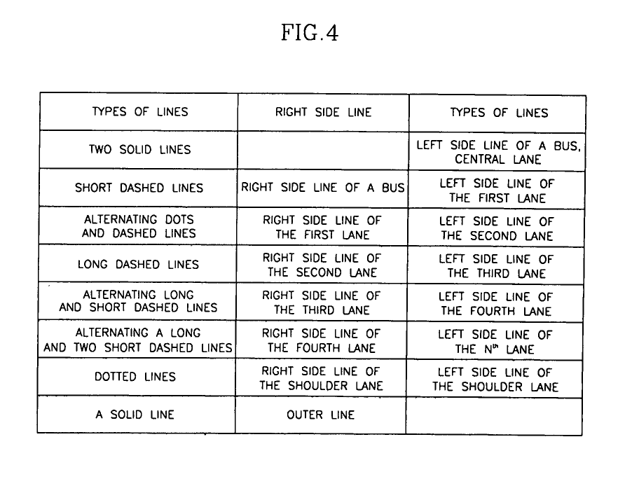

A data of left and right lane boundaries of the vehicle is extracted from the picture photographed in the above step by using an image processor (step 2). Then the lane boundary data thus extracted is compared with a lane recognition pattern data, wherein the lane recognition pattern data is pre-saved under the arrangement shown in FIG. 4 (step 3). Next, whether any lane from the lane boundary data thus provided matches with that of the pre-saved lane recognition pattern data is examined (step 4). If any lane matches with each other in step 4, which lane the vehicle is currently traveling on is determined (step 5). The matching of the lane boundary data with the pre-saved lane recognition data does not need to be exact to determine on which lane the vehicle is currently traveling. In other words, as referred to herein, indicating that the data matches the pre-saved lane recognition does not require that the data match be exact and some deviation can exist between the compared data provided sufficient matching of data occurs to enable a lane assignment However, if no lane matches with each other in step 4, a lane deviation warning is executed (step 6).

That is, as illustrated in FIG. 3, if the left lane boundary of the image photographed via the vision sensor is recognized as a short dashed line and if the pattern of the right lane boundary is recognized as alternating dots and dashed lines, then the vehicle is deemed to be traveling on the first lane.

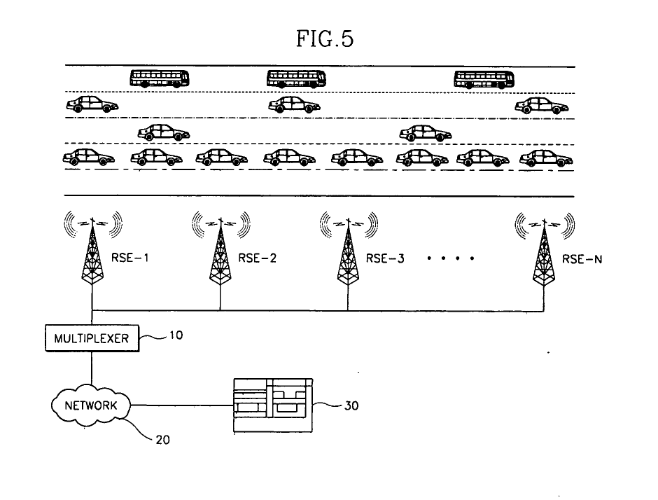

Referring to FIG. 5, in preferred systems, each vehicle is mounted with an On Board Equipment (OBE), and a plurality of Road Side Equipments (RSE-1 to RSE-N) are installed next to the vehicle road.

The Road Side Equipments (RSE-1 to RSE-N) transmit data transmitted from the OBE to a traffic information center 30 via a multiplexer 10 and network 20, wherein the data is transmitted from the OBE to the RSE via the Dedicated Short Range Communication (DSRC). The Road Side Equipments (RSE-1 to RSE-N) also transmit the information transmitted from the traffic information sensor 30 to the relevant OBE.

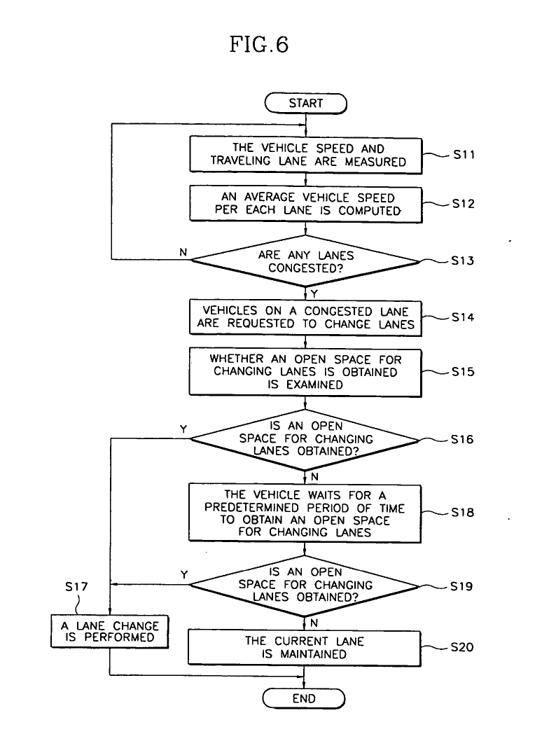

The method for making a lane change performed in the system thus constructed will now be described with reference to FIG. 6.

As shown in FIG. 6, the method for making a lane change according to an embodiment of the present invention includes a step where the OBE measures the vehicle speed via the vehicle speed sensor installed in the vehicle, and the current lane is recognized by the vision sensor as described above. The vehicle speed and the traveling lane information thus obtained are transmitted to the traffic information center 30 via the RSE (step 11).

The traffic information center 30 computes the average vehicle speed per each lane on the basis of the vehicle speed and the traveling lane information inputted from the plurality of vehicles (step 12).

The average vehicle speed per each lane thus computed is compared, and then, whether the average vehicle speed of a certain lane is slower than other lanes is examined (step 13). If the vehicle speed of a certain lane is slow suitably by a noticeable level (e.g. slower by about 1, 2, 3, 4, 5, 8, 10, 15, 20, 25 or more miles per hour), then step 14 is performed. That is, whether a certain lane is particularly congested compared to other lanes is determined.

The traffic information center 30 orders certain vehicles traveling along a congested lane to change to a faster lane via the RSE (step 14).

Next, whether a space has opened for changing lanes is determined (step 15). That is, the open lane is photographed by the vision sensor and whether any impediments such as vehicles or the like are present is determined.

After determining whether an open space for changing lanes is obtained (step 16), step 17 is performed if the space is acquired, and if not, step 18 is carried out.

In step 17, the vehicle changes lanes by activating the steering device. However, in step 18, the vehicle waits for a predetermined period of time for a lane to open up so that the vehicle can change lanes. Provided that an open space for changing lanes is obtained (available), then step 17 is executed to change lanes, and if the space is not obtained, step 20 is executed to maintain the vehicle at the present lane (step 19).

As apparent from the foregoing, methods and systems of the invention provide notable advantages including that a vehicle can be adapted to recognize the lane it is traveling on and to change lanes if the vehicle speed of the current lane is slower than other lanes, thereby contributing to a smooth and effective use of the roadway. While the invention has been described with reference to specific embodiments, modifications and variations of the invention may be constructed with departing from the scope of the invention, which is defined in the following claims.

1. A method for lane recognition, comprising:
determining a visual field of a vehicle traveling on a road delineated with lane marker patterns;
obtaining data of lane boundaries of the vehicle from the determined visual field; and
determining which lane the vehicle is currently traveling on by comparing the lane boundary data with pre-saved lane recognition pattern data.

2. The method of claim 1 wherein the visual field is determined by a vision sensor of the vehicle.

3. The method of claim 1 wherein the visual field is photographed.

4. The method of claim 1, wherein the method for lane recognition further comprises executing a lane deviation warning if the lane boundary data and lane recognition pattern data do not match with each other.

5. A method for lane recognition, comprising:
determining lane boundaries a vehicle traveling on a road delineated with lane marker patterns; and
determining which lane the vehicle is currently traveling on by comparing the determined lane boundaries with pre-saved lane recognition pattern data.

6. A method for making a lane change, comprising:
transmitting speed and current lane information of a vehicle measured by an On Board Equipment (OBE) to a traffic information center via Road Side Equipments (RSE);
computing an average vehicle speed per each lane at the traffic information center on the basis of the vehicle speed and traveling lane information inputted from a plurality of vehicles, then comparing the average vehicle speed per each lane, and if the average vehicle speed of a certain lane is slower than other lanes, then ordering certain vehicles traveling on a congested lane to change their lanes to a faster lane via said RSE;
determining whether an open space for changing lanes is available; and
changing lanes by activating the steering device if an open space for changing lanes is available.

7. The method of claim 6, wherein the method for making a lane change further comprises:
waiting for a predetermined period of time if an open space for changing lanes is not available, and if the space is available, then changing lanes; and
maintaining the vehicle on the current lane if the open space for changing lanes is not available.

8. A method for making a lane change, comprising:
transmitting speed and current lane information of a vehicle measured to an information center;
computing an average vehicle speed per each lane at the information center on the basis of the vehicle speed and traveling lane information inputted from a plurality of vehicles, then comparing the average vehicle speed per each lane, and if the average vehicle speed of a certain lane is slower than other lanes, then ordering certain vehicles traveling on a slower lane to change their lanes to a faster lane; and
determining whether an open space for changing lanes is available.

9. The method of claim 8 wherein an ordered vehicle changes to a faster lane if an open space for changing lanes is available.

10. The method of claim 8 wherein an ordered vehicle changes to a faster lane if an open space for changing lanes is available.

11. The method of claim 8 wherein the method for making a lane change further comprises:
waiting for a predetermined period of time if an open space for changing lanes is not obtained, and if the space is obtained, then changing lanes; and
maintaining the vehicle on the current lane if the open space for changing lanes is not obtained.
